(19) United States
(12) Patent Application Publication
(10) Pub. No.: US 2017/0061781 A1
(43) Pub. Date: Mar. 2, 2017

(54) AUTOMATED COMMUNICATION AND RESPONSE SYSTEM

(71) Applicants: Adam M. Ware, Saratoga Springs, NY (US); Alex Angelillo, Southington, CT (US)

(72) Inventors: Adam M. Ware, Saratoga Springs, NY (US); Alex Angelillo, Southington, CT (US)

(21) Appl. No.: 15/253,271

(22) Filed: Aug. 31, 2016

Related U.S. Application Data
(60) Provisional application No. 62/212,203, filed on Aug. 31, 2015.

(51) Int. Cl. G08B 25/10; F41C 33/02; G11B 20/10; G08B 25/01

(52) U.S. Cl. CPC G08B 25/10; G08B 25/016; F41C 33/029; G11B 20/10527

(57) ABSTRACT

Systems, methods and apparatuses for communicating, collecting and reporting data to a third party as a function of a deployment of a weapon. Embodiments of the present disclosure may be mounted to a user's clothing or integrated into a user's weapon holster, belt or other wearable accessory and include sensors to detect changes in a user's surroundings and further detect the presence or absence of a user's weapon due to the change from a secured position to a readied position. Upon readying a weapon from the a wearable accessory, the systems, methods and apparatuses receive a signal transmitted by the sensor indicating a change in the system's mode of operation as a function of un-holstering the weapon being monitored. In the active mode, the systems methods and apparatuses collect audio and video data and transmit the collected data to one or more third parties via a network connection.

### CROSS REFERENCE TO RELATED APPLICATIONS

This application claims the priority and benefit of U.S. Patent Application No. 62/212,203 entitled “WEAPON HOLSTER”, filed on Aug. 31, 2015, the contents of which are hereby incorporated by reference.

### FIELD OF TECHNOLOGY

The following relates generally to a system, apparatus and method for automating communication, data collection and reporting, and more specifically to systems, apparatuses and methods for initiating, transmitting and receiving electronic, voice, sound and video data between a user and a third party in response to changes in a status of a weapon.

### BACKGROUND

Police offices, soldiers, personal security guards and other occupations requiring personnel to be armed, are consistently at a risk for occupational hazards as part of their regular employment activities. Often when faced with an unexpected occupational hazard, communication with other members of a team may be critical or crucial to the success and safety of each personnel member. In many dangerous or life threatening situations, armed personnel may need to make split second decisions to properly neutralize threats, and reduce the dangers presented. Occasionally, the means for threat neutralization may require lethal or non-lethal force. However, during these moments where quick decisions are required, additional protocols or safety measures may be needed in order to safely address the situations in a timely or effective manner. These added protocols and safety measures may require the personnel to report situations to a central dispatcher, request for back up or to record evidence of the situations to further validate actions taken by the personnel.

One distinct indication that a situation may be hostile, dangerous or hazardous to the armed personnel may be through the actions of the armed personnel un-holstering and drawing their weapon. Un-holstering or drawing a weapon may identify that the situation has become dangerous enough in the minds of the personnel that a display of force may be a warranted response or necessary to safely manage the potential threat. When a situation has escalated to the point where deadly force is being raised as an option, police and other armed personnel protocols may require personnel to report the situation to a dispatcher, provide location information, collect crime-related evidence, request additional manpower to assist with the situation or record the interaction between the personnel and the other individual(s) for the purposes of evidence or justifying the use of the force.

Currently available reporting and communication tools are not automated or hands free. These systems are operated manually, often by hand, and can divert the attention of the armed personnel from the situation unfolding in front of them. Delays, distractions and diverted attention of armed personnel for the purposes of protocol compliance, even for a time period amounting to fractions of a second could result in injury or possibly the death of the individuals involved in the situation or any nearby bystanders. Currently available systems may require personnel to remove one of their hands from their weapon, or divert the individual's gaze from the situation or other individuals that should warrant the armed personnel's full attention. Accordingly, there is need for an automated, hands-free, apparatus and method capable of reporting, recording and transmitting information surrounding a dangerous or hazardous situation that may arise, to a third party that may provide additional assistance and support to the armed personnel.

### SUMMARY

A first aspect of this disclosure relates generally to a method for automating communication comprising the steps of: providing a wearable accessory comprising a sensor and a computer system connected to the sensor; receiving, by the computer system, sensor data establishing an initial signal of the sensor, wherein the initial signal is detecting a presence of a weapon in a secured position; detecting, by the computer system, an alteration to the initial signal of the sensor, indicating a change in the presence of the weapon in a secured position; activating, by the computer system, a peripheral device connected to the computer system, as a function of the alteration to the initial signal of the sensor; receiving, by the computer system, data collected by the peripheral device selected from the group consisting of audio data, video data, voice data and environmental data; and transmitting, by the computer system, the data collected by the peripheral device to a network computer system connected to the computer system.

A second aspect of this disclosure relates generally to a computer system comprising a processor; a memory device coupled to the processor; a wearable accessory connected to a sensor coupled to the processor; and a computer readable storage device couple to the processor, wherein the storage device contains program code executable by the processor via the memory device to implement a method for automating communication comprising the steps of: receiving, by the processor, sensor data establishing an initial signal of the sensor, wherein the initial signal is detecting a presence of a weapon in a secured position; detecting, by the processor, an alteration to the initial signal of the sensor, indicating a change in the presence of the weapon in a secured position; activating, by the processor, a peripheral device connected to the computer system, as a function of the alteration to the initial signal of the sensor; receiving, by the processor, data collected by the peripheral device selected from the group consisting of audio data, video data, voice data and environmental data; and transmitting, by the processor, the data collected by the peripheral device to a network computer system connected to the computer system.

A third aspect of this disclosure relates generally to a computer program product comprising one or more computer readable hardware storage devices having computer readable program code stored therein, said program code containing instructions executable by the one or processors to implement a method for automating communication comprising the steps of: receiving, by the processor, sensor data establishing an initial signal of a sensor, wherein the initial signal is detecting a presence of a weapon secured into a holster; detecting, by the processor, an alteration to the initial signal of the sensor, indicating a removal of the weapon from the holster; activating, by the processor, a microphone and a camera connected to the holster, as a function of the alteration to the initial signal of the sensor; receiving, by the processor, data collected by the microphone and camera selected from the group consisting of audio data, video data, voice data and environmental data; and transmitting, by the processor, the data collected by the microphone and the camera to a network computer system electronically paired to the processor, wherein the network computer system is a mobile communication device.

### BRIEF DESCRIPTION OF THE DRAWINGS

Some of the embodiments will be described in detail, with reference to the following figures, wherein like designations denote like members:

FIG. 1a depicts a block diagram of an embodiment automated communication and response system.

FIG. 1b depicts a block diagram an alternative embodiment of an automated communication and response system.

FIG. 1c depicts an exterior side view of an embodiment of an automated communication and response system.

FIG. 2 depicts a side cutaway view of the automated communication and response system embodiment of FIG. 1c.

FIG. 3a depicts an isometric exterior view of an embodiment of a computer system of the automated communication and response system consistent with the disclosure.

FIG. 3b depicts a top view of the interior of the computer system embodiment depicted in FIG. 3a.

FIG. 3c depicts a schematic view of an embodiment of an electrical circuit of the automated communication and response system.

FIG. 4 depicts an embodiment of a general purpose computing system.

FIG. 5a depicts an embodiment of a network-accessible computing system loaded with program code for automating communication and responses between multiple parties.

FIG. 5b depicts the embodiment of the computing system of FIG. 5a collecting and transmitting audio data to a third party.

FIG. 6 depicts a flow chart of a method for automating communication and responses between multiple parties, consistent with the disclosure of the current application.

FIG. 7 depicts a flow chart describing an alternative embodiment of a method for automating communication.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, the order in which method steps are performed etc., and are disclosed simply as an example of embodiments of the present disclosure. A more complete understanding of the present embodiments and advantages thereof may be acquired by referring to the following description taken in conjunction with the accompanying drawings, in which like reference numbers indicate like features.

As a preface to the detailed description, it should be noted that, as used in this specification and the appended claims, the singular forms “a”, “an” and “the” include plural referents, unless the context clearly dictates otherwise.

### Overview

Embodiments of the present disclosure may solve the problems associated with manually operated communication systems utilized by law enforcement and other types of armed personnel, such as security, military, military contractors, etc. (hereinafter “user” or “users”). Unlike manually operated systems such as body-mounted cameras and microphones, dash mounted computer devices, radio transmitters or a personal mobile device, which require manipulation and user input by the associated user to collect data of the user's surroundings, nearby third parties or request assistance, embodiments of the present disclosure may operate automatically to collect, record and store audio and visual data, open lines of communication with a dispatcher or other third party as a function of changes in the user's situation.

Embodiments of the present disclosure may be mounted to a user's clothing or integrated into a user's weapon holster, belt or other wearable accessory. Sensors or switches connected to the system may detect changes in the user's surroundings and in some embodiments detect the presence or absence of a user's weapon due to the change from a holstered position to a readied position. Upon drawing the weapon from the holster, the system may receive a signal transmitted by a switch or sensor indicating the change in the system's mode of operation as a function of un-holstering the weapon monitored by the system. For example, drawing the weapon from the holster may indicate to the system to change from a standby mode to an active mode.

Upon switching from a standby, holstered mode to an active, un-holstered mode, the automated communication and response system may activate one or more input devices placed in electronic communication with the system. The input devices may be capable of collecting audio or video data of the user's surroundings and potential perpetrators. Furthermore, upon entering the active, un-holstered mode, the system may proceed to transmit video data, audio data, voice data and/or location data to a dispatcher or other third party having a network connection with the system, in order to report the user's location, provide facts surrounding the situation, request backup or emergency services.

### System for Automating Communications, Data Collection and Reporting

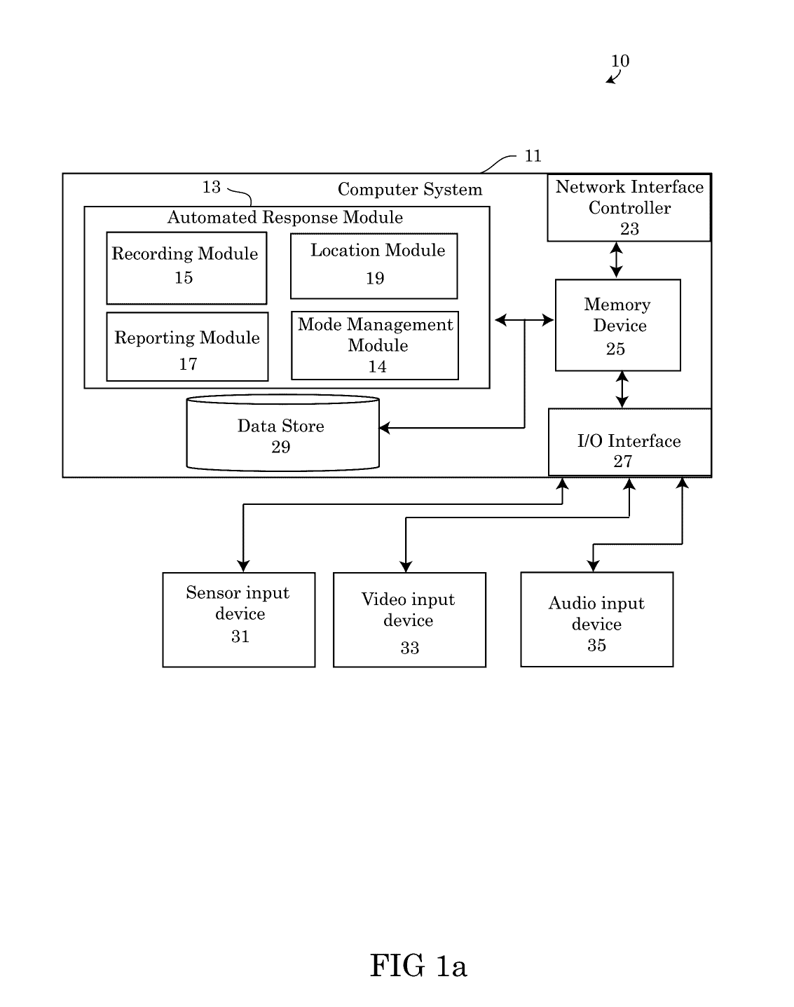

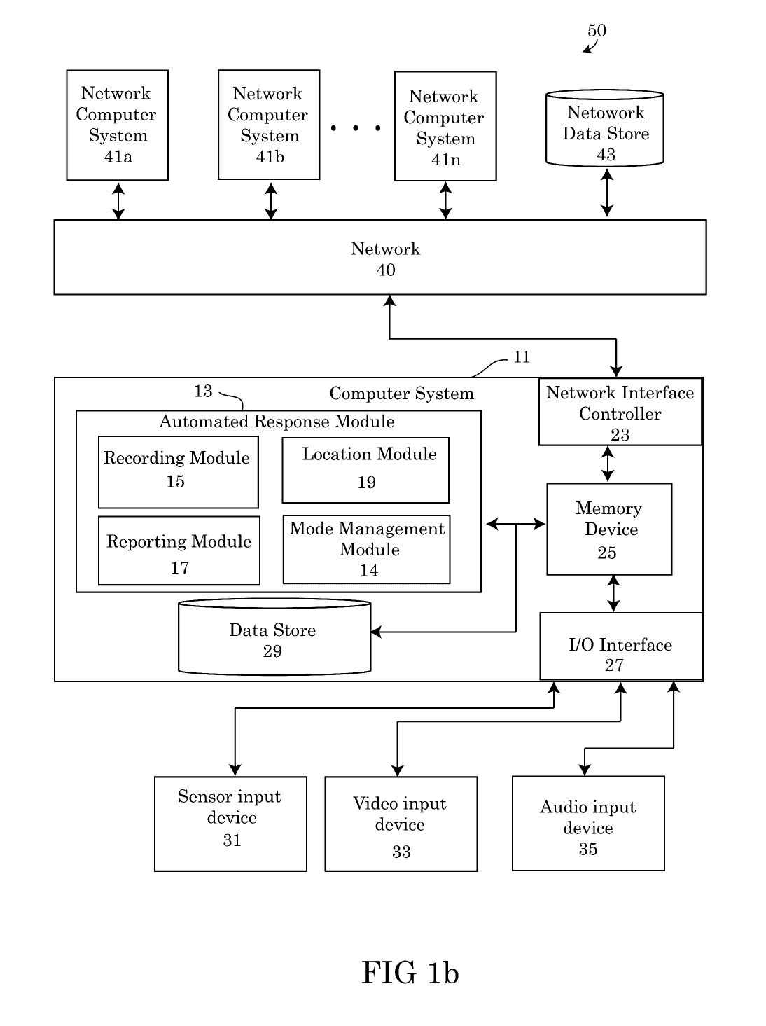

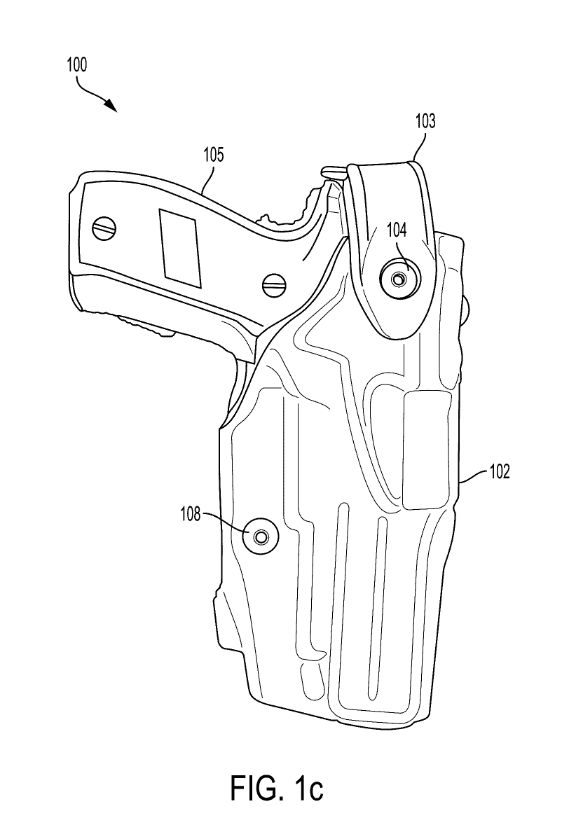

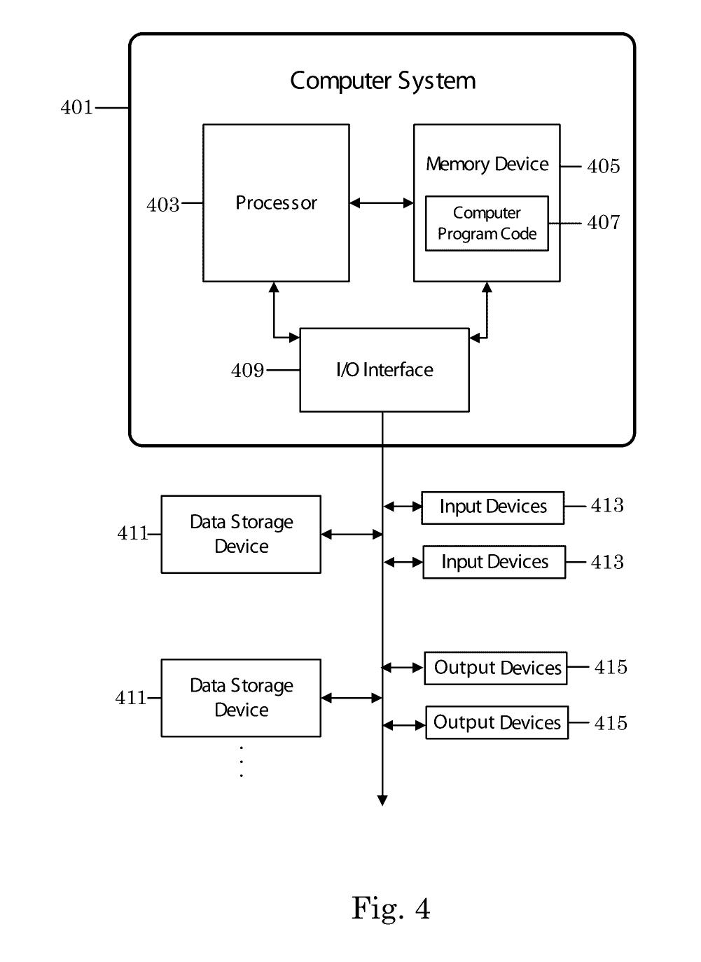

Referring to the drawings, FIG. 1a depicts a block diagram of an embodiment of an automated communication, data collection and reporting system 10. Embodiments of the system 10 may include a computer system 11. The computer system 11 may be a specialized computer system, having specialized configurations of hardware, software or a combination thereof as depicted FIGS. 1a, 1b, 2-3c, 5a-5b of the present disclosure in some embodiments. Embodiments of the computer system 11 may also comprise one or more elements of the generic computer system of FIG. 4 as described in detail below. Elements of the generic computer system of FIG. 4 may be integrated into the specialized computer system 11 of FIGS. 1a, 1b, 2-3c, 5a-5b.

In some embodiments, the computer system 11 of system 10 may include an automated response module 13. A “module” may refer to may refer to a hardware based module, software based module or a module may be a combination of hardware and software resources. A module (whether hardware, software, or a combination thereof) may be designed to implement or execute one or more particular functions, tasks or routines. Embodiments of hardware based modules may include self-contained components such as chipsets, specialized circuitry and one or more memory devices, while a software-based module may be part of a computer program code 470 or linked to computer program code 470 containing specific programmed instructions loaded in the memory device 25, 405 of computer system 11, 401, a remotely accessible memory device such as an onboard memory device of a networked computer system 41a, 41b . . . 41n (referred to hereinafter as networked computer system 41) or a network data store 43.

In some embodiments of the automated system 10 described in this disclosure, the system 10 may include a recording module 15. The recording module 15 may be specialized hardware having specialized circuitry and/or a software based recording module 15 that may comprise computer program instructions loaded into the memory device 25, 405 of the computer system 11, 401 or a remotely accessible network computer system 41. The recording module 15 may be responsible for performing the tasks of recording audio data, video data, voice data or other types of data, via one or more input devices 413 connected to the computer system 11, 401. For example, the recording module 15, once activated by the computer system 11, may initiate and perform the recordation of video data using a video input device 33 such as a camera. Moreover, the recording module 15 may further be initiated by the computer system 11 to record audio data using an audio input device 35, for example, a microphone 304. Embodiments of the recording module 15 may control the recording actions performed by the video input device 33 and audio reporting device 35, retrieve the recorded data from memory device 25, 405 and/or store the recorded data in a computer accessible storage device such as a data store 29, data storage device 411, network data store 43, data mart or other data storage system known by a person skilled in the art. The recorded data may be stored in a manner that may allow for transmission to other network computer systems 41 or subsequent retrieval at a later date and time.

In some embodiments of the automated system 10, the automated response module 13 of the computer system 11 may include a location module 19. The location module may include hardware and/or software capable of utilizing the global positioning system (GPS). For example a GPS antenna, transmitter, transponder, transceiver or receiver may be connected to the computer system 11 or integrated into the hardware of location module 19. The location module 19 may acquire the GPS location from GPS satellites and may store data relating to the location of the computer system 11 in the memory device 25 or the data store 29. When a request is made by the computing system 11 to provide location data, the location module 19 may provide alongside the request, GPS or other location information in order to more specifically identify the computer system 11. The location data may assist network computer systems 41 receiving the location data with providing assistance to a particular location last transmitted by the computer system 11.

Embodiments of the location module 19 may save, store and update one or more sets of location information, as the computer system 11 moves from one location to another. The location module 19 may communicate with the reporting module 17 to communication GPS information and coordinates to other computer systems tracking the location of computer system 11. For example, a police officer equipped with the automated response system 11 may be in communication with a dispatcher operating a network computer system 41. The computer system 11 may periodically transmit location data acquired by the location module 19 in order to allow the dispatcher's networked computer system 41 to track the officer's location. In the event that assistance may be requested, the assistance may be directed by the network computer system 41 to the last known location of computer system 11.

Embodiments of the automated response module 13 may further include a mode management module 14. The mode management module 14 may be responsible for collecting sensor data transmitted by sensor input device 31. The mode management module 13 may operate by changing modes of the system 10 as a function of the sensor data collected. The mode management module 14 may make a determination whether the system 10 should remain in a standby mode or enter active mode based on the presence or absence of the sensor data detecting the presence of firearm or another weapon in a secured or readied position.

For example, the sensor input device 31 may be transmitting to the computer system 11 and more particularly the mode management module 14, sensor data detecting the presence of a weapon in a holstered or other secured position. While the weapon is in the holstered position, the mode management module 14 may maintain the automated response module 13 in standby mode. Subsequently, the sensor input device 31 may transmit sensor data to the mode management module 14 indicating a change in position of the weapon from a secured position to a readied position. As a result of the change in position of the weapon as detected by the sensor input device 31, the mode management module 14 may place the automated response module 13 into an active mode. While in active mode, the automated response module may activate the recording module 15 to begin collecting recorded audio and video data, the location module 19 to identify and transmit the location data of the computer system 11 and instruct the reporting module 17 to begin transmitting and reporting the collected data and/or location data of the computer system 11 to one or more network computer systems 41 connected to the computer system 11 via a network 40.

As noted above, some embodiments of the system 10 may include remote connections between computer system 11 and one or more resources of a computer network 40 as shown in embodiment 50 of FIG. 1b. The reporting module 17 may be responsible for sending and receiving data between devices connected to the network, including the transmission of audio and video recorded data collected by the recording module 15. The reporting module 17 may utilize accessible resources of the computer network 40 to open a line of communication with a third party or other members of the network 40. The network 40 may be a group of computer systems or other computing hardware devices linked together through communication channels to facilitate communication and resource sharing among the computer systems and hardware devices. Examples of network 40 may include a local area network (LAN), home area network (HAN), wide area network (WAN), mobile communications network, back bone networks (BBN), peer to peer networks (P2P), campus networks, enterprise networks, the Internet, cloud computing networks and any other network known by a person skilled in the art.

Embodiments of the computer system 11 may access the network via a network interface controller 23. The network interface controller may be a wired or wireless antenna, transmitter, receiver, transceiver or transponder capable of emitting and receiving data signals. In some embodiments, the signals and data being transmitted wirelessly For example, the network 40 may be a wireless network established using Wi-Fi, Bluetooth, Bluetooth low energy (BLE), ZigBee, WiMax, light fidelity (Li-Fi), infrared or other wireless communication protocols known by those skilled in the art.

The computer system 11 may communicate via the established network 40 to one or more networked computer systems 41a, 41b . . . 41n which may also be connected to the network 40. The reference numbers with sub-letters and ellipses, for example describing the networked computer systems 41a, 41b . . . 41n may signify that the embodiments are not limited only to the amount of elements actually shown in the drawings, but rather, the ellipses between the letters and the n^{th} element indicate a variable number of similar elements of a similar type. For instance, with regard to the networked computer systems 41, a plurality of networked computer systems 41 may be connected to the network at any particular time up to the nth number of computer systems wherein the variable “n” may represent the last element in a sequence of similar elements shown in the drawing.

Embodiments of the network computer systems 41 may be any type generic computer system, such as the system 401 described by FIG. 4 or specialized of computer systems such as the computer systems 10, 100, 200, 500a, 500b described in FIGS. 1a-3c, 5a, 5b. In some embodiments, the networked computer systems 41 may perform a particular function or action requested by the computer system 11. For example, a network computer system 41 may be a mobile communication device of the user of computer system 11. The mobile communications device may be remotely accessible and performing onboard functions at the request of the computer system 11. In some embodiments, the network computer system 41 may be a colleague, fellow office or other staff responsible for tracking and assisting the user of computer system 11, such as a dispatcher who may take a particular action in response to the mode management module 14 entering an active mode or receive audio and video information collected by the recording module 15 via a reporting module 17.

For example, a police officer equipped with computer system 11 may be connected to network 40, which may comprise a plurality of network computer systems 41, including the officer's mobile device, a dispatcher and a second police office's computer terminal or radio. The sensor input device 31 may detect that the officer has removed a firearm or other weapon from the officer's holster or other weapon securing device. The mode management module 14, receiving the sensor data may identify that the firearm has been removed and alert the recording module 15 to begin recording audio and video data using the video input device 33 and audio input device 35 connected to the system via I/O interface 27. Concurrently, the reporting module 17 may contact via network 40 the dispatcher and/or a second officer connected to the network 40 for assistance. The reporting module may transmit via the network, the officer's location data collected by the location module 19 and the audio/video data. The reporting module may additionally open a line of communication with the dispatcher or second police office to allow for verbal communication in live-time. The reporting module may establish the verbal communication using either an onboard device of the computer system, or using the remotely accessible mobile device of the officer.

Referring back to drawings, FIG. 1c, depicts a more specific embodiment of an automated communication system 10, 50 integrated into a weapon holster 100 or other wearable device capable of detecting the presence of a weapon in both a secured or readied position. Embodiments the weapon holster 100 may be designed to fit or accommodate a plurality of different weapon types. The weapon holster 100 may vary in size and shape depending on the desired weapon 105 elected to be carried by the user of the holster 100. An example of weapon 105 may be a sidearm. Further examples of weapons that may designed to fit the weapon holster 100 in some embodiments, may include lethal weapons such as firearms, including but not limited to pistols, handguns, and revolvers. In other embodiments, the holster 100 may be designed to accommodate electroshock weapons such as Tasers or stun guns, blunt weapons such as batons, truncheons and nightsticks, crowd control devices such as pepper spray or bladed weapons such as knives and daggers.

Embodiments of the holster 100 may include an exterior holster body 102. The holster body 102 may be constructed out of any rigid or semi-pliable material that may be shaped to form around the weapon 105. The holster body 102 may be shaped in a manner that may form an interior cavity 106 wherein the weapon 105 may be placed and secured within the interior cavity 106. A weapon 105 inserted into the interior cavity 106 of holster 100 may be concealed or partially concealed by the material of the exterior holster body 102. Suitable material for embodiment of the exterior holster body 102 may include but are not limited to leather, molded plastics, rubberized fabrics or ballistic fabric weaves. The holster body 102 materials (in addition to leather) may include examples such as nylon, foam, rubber, polycarbonate, Kydex®, high-density polyethylene (HDPE) acrylic-polyvinyl chloride or polyethylene terephthalate.

In some embodiments, the automated communication system 11 integrated into holster 100 may be equipped with the sensor input device 31. The sensor input device 31 may be capable of identifying the presence or absence of weapon 105 inside the interior cavity 106 of the holster 100. The sensor input device 31 may create an initial detection signal setting the initial signal of a sensor. The initial detection signal may indicate the presence of the weapon situated in the holster 100 or other securing device. Alterations to the initial signal established by the sensor, may occur in response to physical stimuli detected by the sensor input device 31. For example, changes to the stimuli detected by the sensors of the sensor input device 31 may include changes in electrical voltage, electrical resistance, frequency of waves, amplitude of waves, the presence of light, timing of a return wave, pressure increases, motion detection or any other measured physical response that may be measured by the sensor input device 31 and transmitted to the computing system 11 and/or the mode management module 14.

Each sensor input device 31 may transmit detection signals and reporting signals, including data signals measuring the output signals from the sensors attached to the holster 100. The sensor input device 31 may transmit and receive signals and data between computer system 11 and the sensor input device 31. In some embodiments, an input/output (I/O) interface 27 may control and direct the signals being transmitted and received to and from the sensor input device 31 and computer system 11. An I/O interface 27 may refer to any communication process performed between the computer system 11 and the environment outside of the computer system 11. “Input” may refer to the signals or instructions sent to the computer 11 from a source outside of the computer system (for example: the sensor input device 31) while “output” may refer to the signals sent out from the computer system 11, to the sensor input device 31. The signals, data and other information transmitted or received by the computer system 11 may be stored by one or more memory devices 25, data stores 29, network data stores or any other data storage device, and may be recalled or further transmitted to the automated response module 13 for further processing as requested by the computer system 11 or network computer system 41.

Examples of the sensor input device 31 may include devices comprising one or more classes of sensors including an optical sensor, electro-optical sensor, optical switch, proximity sensor, motion sensor, acoustic sensor, mechanical sensor environmental sensor, magnetic sensor or any other type of sensor that may detect the presence or absence of a physical stimulus entering or leaving a detection zone or area of the sensor (i.e. the presence or absence of the weapon 105 inside the holster 100). Embodiments of optical sensors, electro-optical sensors and optical switches integrated into the sensor input device 31 may convert light rays into electric signals, thereby allowing for the measurement of a physical quantity of light than can be translated into a form that is readable by an instrument, such as the sensor input device 31 or an attached computer system 11. Embodiments of the optical sensors, electro-optical sensors and optical switches may include a trigger that may react to a change or alteration to the signal being emitted by the optical or electro-optical sensor. When a measurable change occurs to the light ray being emitted, the optical or electro-optical sensor may operate as a photoelectric trigger and either increase or decrease an electrical output indicating a change in position of the weapon 105 in relation to the holster 100 or other apparatus having the sensor input device integrated therein.

In alternative embodiments, instead of using optical sensors to measure and respond to changes in a physical stimulus affecting the position of the weapon 105, the sensor input device 31 of the holster 100, may be equipped with a proximity sensor that may be capable of detecting the presence of nearby objects without making any physical contact. A proximity sensor may operate by emitting an electromagnetic field or a beam of electromagnetic radiation (such as infrared). The proximity sensor identifies changes in the field or a return signal. Different proximity sensors may be used depending on the type of obstruction intended to be identified. For example a capacitive or photoelectric proximity sensor may be suitable for plastic targets whereas an inductive proximity sensor may be more suitable for a metal obstruction target.

An acoustic sensor on the other hand integrated as part of the sensor input device 31 and may rely on the modulation of surface acoustic waves to sense physical phenomenon or stimuli. Embodiments of the acoustic sensor may transduce an electrical signal input into a mechanical wave and then may transduce the wave back into an electrical signal, whereby changes in amplitude, frequency and time-delay between the input and output electrical signals can be used to measure the presence or absence of a physical stimuli or phenomenon, such as the presence or absence of a weapon 105 inside the interior cavity 106 of the holster 100.

In some embodiments of the sensor input device 31, a mechanical sensor may be employed. The mechanical sensor class may include numerous different types of sensors that may operate using various principles to sense mechanical quantities, either directly or indirectly. Mechanical sensors may measure differences in various properties of the sensor and the surroundings such as the stress, force, torque, acceleration, or position of the sensor or sensor components (such as springs, plates, wire resistance, liquid or gases and the pressures they exert) when a force, pressure or load displaces the sensor signals as a result of the obstruction.

Examples of mechanical sensors that may be employed to measure and detect the presence of a weapon 105 may include strain gauges (including metallic, wire, resistive, semiconductor and optical fiber strain gauges), tactile sensors, force sensitive resistors (FSR sensor), accelerometers (for example: capacitive accelerometers, strain gauge accelerometers, variable inductance accelerometers, magnetic accelerometers, heated gas accelerometers, optical fiber accelerometers, multi-axis accelerometers), pressure sensors (for example: mechanical pressure sensors, bellows, diaphragm pressure sensor, membrane and plate sensors, piezo resistive pressure sensors, differential pressure sensors, capacitive pressure sensors, magnetic pressure sensors, optoelectronic pressure sensors, Fabri-Perot optical resonator, vacuum sensors), gyroscopes (mechanical, Coriolis force, optical, resonant fiber optic and coil optical fiber gyroscopes).

In some embodiments, magnetic sensors may be employed or incorporated into the sensor input device 31. Magnetic sensors may include a microelectromechanical (MEMS) device capable of detecting and measuring magnetic fields. Magnetic sensors may electronically detect and measure changes in voltage or resonant frequency in some embodiments. In alternative embodiments, the magnetic sensors may measure mechanical displacement using voltage sensing, frequency shift sensing or optical sensing. For example a Lorentz-force-based MEMS sensor may rely on mechanical motion of the MEMS structure occurring due to the Lorentz force acting on the current-carrying conductor in the magnetic field. The mechanical motion of the micro-structure may be sensed either electronically or optically. The mechanical structure may be driven to its resonance frequency in order to obtain the maximum output signal. In some embodiments, Piezo resistive and electrostatic transduction methods can be used in the electronic detection. Displacement measurements may also be made optically using a laser source or LED source.

In some embodiments of the sensor input device 31, the sensor input device 31 may include a range-finding sensor incorporated therein. Similar to the acoustic or sound sensors described above, the range finding sensor may detect the presence of obstacles in the path of the sensor by propagating sounds waves. These sound waves may bounce off of a reflective surface and return to the sensor. The sensor input device 31, or the computer system 11 connected to the sensor input device 31 may calculate the amount of time it takes for the wave to return to the range finder sensor. When an object is detected, such as the weapon 105 inside the holster, the wave may shorten and the amount of time for the wave to return will reduce, allowing the sensor input device 31 to indicate that the weapon 105 is placed inside the holster. Likewise, when the weapon 105 is removed, the interval between the time for the wave to return will be longer, thus indicating to the sensor input device 31 or the computer system 11 that there is a lack of the weapon 105 present in the holster 100.

In some alternative embodiments of the system 11 the holster 100 may use mechanical or electromechanical means for detecting the presence of a weapon 105 in the holster 100 or other weapon securing device. For example, in some embodiments, the system 11 may include a mechanically or electromechanically operated switching mechanism 103, which may be accessible from the exterior of the holster 100. In some embodiments, the switching mechanism 103 may act as the sensor input device 31. Upon changing the position of the switching mechanism 103, the sensor input device 31 may send a signal to the computer system 11 indicating a change in the switching mechanism's position, resulting in a switching of the mode by the mode management system from standby to an active mode. In the embodiment of FIG. 1c, the switching mechanism 103 may be a pivoting holster strap that may rotate positions. For example, as shown in FIG. 1c, the strap of the switching mechanism 103 may be connected to the holster body 102 by a fastener 104. Fasteners may include various combinations of known bolts, nuts, screws, washers, locking washers, snap fasteners, anchors, pins, staples, etc.

In the embodiment depicted in FIG. 1c, the strap of the switching mechanism may rotate axially around the fastener 104, allowing the strap to change positions. When the holstered weapon 105 is secured within the interior cavity 106 of holster 100 by the switching mechanism (in this case a strap), the switch may be considered to be in the standby state. Subsequently, when the user of the holster 100 desires to withdraw the weapon, the user may rotate the switching mechanism 103 forward by rotating the switching mechanism around the fastener, allowing for the weapon 105 to be removed from the holster 100. Once the switching mechanism 103 has been rotated and moved into the forward position, the switching mechanism 103 may enter the active state, due to the change in the switching mechanism's position sending a signal to the computer system 11 and the automated communication module 13 to change from a standby to an active state.

In some embodiments, the switching mechanism 103 may be an electromechanical device having one or more sets of electrical contacts that form part of an electrical circuit. The contacts with the electrical circuit may be positioned in one of two states. The first state may be considered an opened state. In the “open” state, the contacts of the switching mechanism may be separated and therefore not conducting electricity through the electrical circuit. The other state of the switching mechanism 103 may be the “closed” state. When embodiments of the switching mechanism 103 are placed in the closed state, the electrical contacts may be touching, allowing electricity to continue its flow through the circuit, completing the electrical circuit and allowing electricity to flow to the computer system 11 or an electrical sensor of the sensor input device 31. Once the sensor of the sensor input device 31 or the computer system 11 are energized, the computer system 11 may initiate recording audio or visual data by the recording module, transmit the audio or visual data to a network computing system 41 or other third party, or open a line of communication to the third party.

In alternative embodiments, the positioning of the strap or the conductance of the electrical contacts may be reversed from the scenarios described previously. Changing the position of the mechanical or electromechanical switching mechanism 103 to the opposite position, may initiate the sensor input device 31 or the electrical circuit to send a signal back to the computer system 11 to instructing the computer system 11 to return to the standby mode and therefore stop recording audio data, visual data or transmitting the data to a third party or contact the third party.

Embodiments of the switching mechanism 103 are not limited to only a rotational strap affixed to the holster body 102. The switching may be any mechanism capable of transmitting a signal to the computer system 11 indicating to the computer system 11 when to change modes from standby to active, thus indicating to the computer system when the computer system 11 should record and transmit the recorded data, location data and open lines of communication with a third party. In some embodiments the switching mechanism may include toggle switches, contact switches, push button switches, selector switches, proximity switches or pressure switches. In the exemplary embodiments however, one or more sensors may be used as described above to detect the presence or absence of a weapon 105 within the internal cavity 106 of the holster 100. In some embodiments, when the weapon 105 is present in the cavity 106 of the holster 100, the switching mechanism (in this embodiment, the sensors) may detect a change in the initial or detection signal, depending on the configuration of the holster system. When the weapon 105 is removed from the holster 100, the signal being sent to the sensors may be altered in some embodiments, or disengaged in others, thus sending a signal to the computer system 11 and more specifically to the mode management module 14 to change the current mode from standby to the active mode or vice versa. Examples of sensor types that may be used to detect the presence or absence of a weapon 105 within the internal cavity 106 of the holster 100 may include, but is not limited to one or more optical sensors, infrared (IR) sensors, PIR sensors, pyroelectric sensors, ultra-sonic sensors, proximity sensors, displacement sensors, magnetic sensors, motion detectors, gyroscopes, accelerometers and differential pressure sensors.

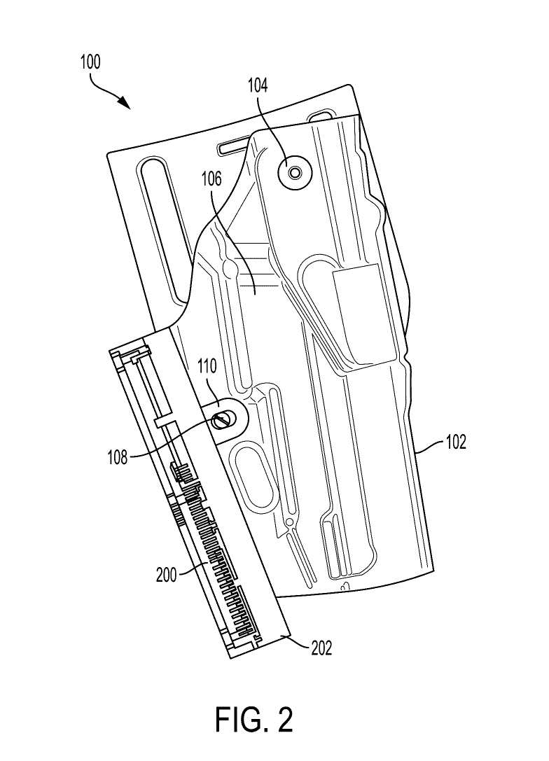

FIG. 2, 3A, 3B depict an embodiment of a particular type of computer system 11 that may be integrated into or placed in communication with the sensor input device 31 equipped on the holster 100. In some embodiments, the computer system 11 may be referred to as control unit 200. A control unit 200 may include specialized components, modules or circuitry that perform one or more operations as described for computer system 11 in systems 10, 50.

The control unit 200 may allow for a computing system's logic unit, memory, as well as input and output devices to respond to instructions received from computerized program coded loaded in the memory of the control unit 200. In some embodiments, the control unit 200 may be affixed to the holster 100. In the embodiment shown in FIG. 2, the control unit 200 may affixed within the interior cavity 106 of the holster 100 at one or more attachment points 110 extending along or connected to the housing 202 which may surround and protect the interior components of the control unit 200. In alternative embodiments, the control unit 200 or other types of computer system 200 may be attached to the exterior of holster 100, or embedded within the material of the holster 100. At each of the attachment points 110, a control unit fastener 108 may extend through the attachment point 110 and secure or affix the control unit 200 to an interior surface of the holster body 102. By attaching the control unit 200 to the interior surface of the holster body's 102 interior cavity 106, the control unit 200 may be protected by the rigid material of the holster body 102 from damage, dust or debris that may harm or damage the components of the control unit 200.

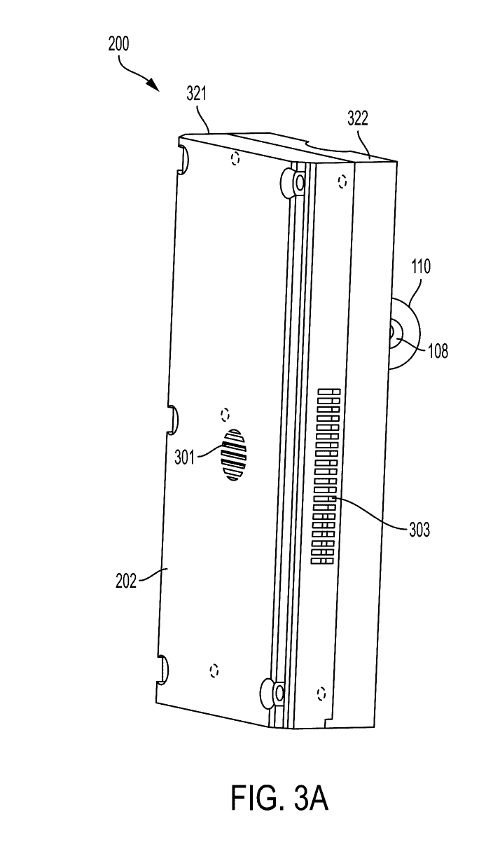

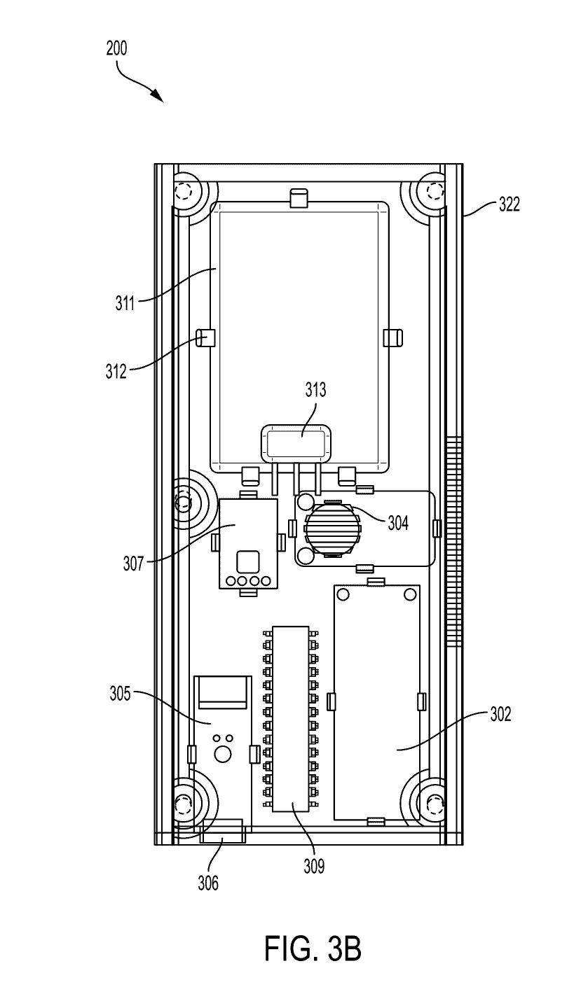

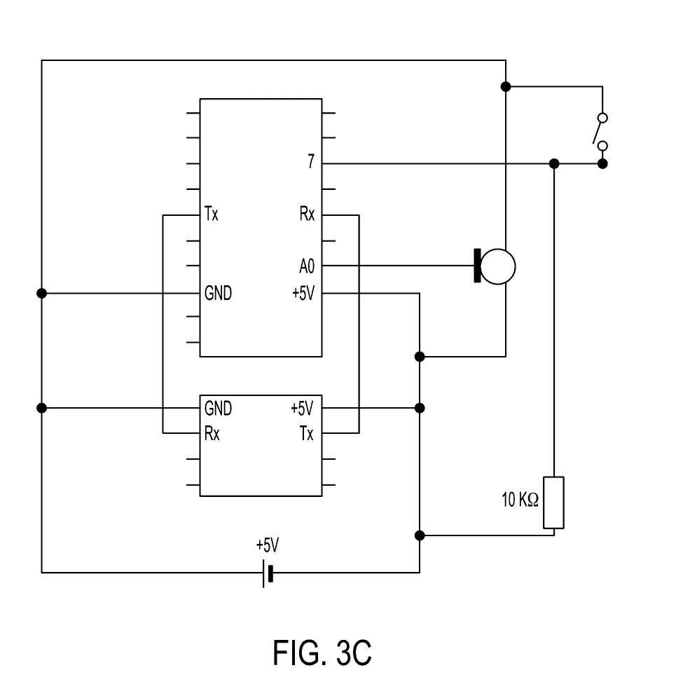

Embodiments of the control unit 200 may further include a control unit housing 202 constructed out of a hard, rigid material, such as polymeric resin, injectable or molded plastic, metal or metal alloys, or a combination of materials. The control unit housing 202 may provide added protection or a covering for the components housed within the control unit 200. Embodiment of the housing 202 may include multiple ports, including a microphone port 301 and a ventilation port 303. A “port” may refer an opening located along the surface of the control unit housing that allows something to pass from the interior of the control unit 200 to the exterior of the control unit 200 or vice versa. For example, in the exemplary embodiment, the control unit housing 202 includes microphone port 301, which may be placed directly over or near the microphone 304 component within the interior of the control body 202. The opening of the microphone port 301 may allow for sound waves from a user's voice, or the surrounding environment, to more easily be received and/or recorded by the microphone 304. The microphone port 301 may reduce the amount of interference which may be caused by the protective covering of the control unit housing 202. The microphone port 301 may be an open port directly exposing the microphone 304, or in some embodiments, such as the one shown in FIG. 3A, the port 301 may be a vented port comprising horizontal or vertical crosshatching of the control unit housing material.

Another example of a port may be a ventilation port 303. Similar to the microphone port 301, the ventilation port 303 may reduce interference between interior and exterior of the control unit housing 202. Namely, the ventilation port may allow for increased airflow, which may assist in removing warm air from inside the control unit 200 and thus keep each of the components inside the control unit at a tolerable temperature for continued operation. Similar to the microphone port 301, the ventilation port may be an open port or it may be cross hatched with vertical or horizontal cross hatching comprised of the same material as the control unit housing 202.

Embodiments of the control unit housing 202 may include a plurality of segments attached together. These segments may be fastened together using a fastener such as a bolt, screw or push pins, in some embodiments. In alternative embodiments, each of the segments of the control unit body 202 may include snap fittings that connect and disconnect from one another. In the exemplary embodiment, the control unit body 202 may be separated into two pieces, a cover piece 321 and an opposing base piece 322 that may support one or more internal components of the control unit 200. In some embodiments, one or more of the internal components may be affixed or supported directly onto either the cover piece 321 or the based piece 322.

Referring back to the drawings, FIG. 3b depicts an embodiment of the control unit 200, wherein each of the internal components may be affixed to the control unit housing 202. Embodiments of the control unit 200 may be comprised one or more of the following internal components: a power supply 311, a resonator 313, a voltage regulator 307, a microphone 304 (or other audio input device 35 and/or video input device 33), a power supply charger 305 which may include a charging port 306, a transmitter or transceiver 302 and a microcontroller 309.

Embodiments of the internal components of the control unit 200 may be affixed to the control unit housing using a plurality of attachment members 312 which may extend from the control unit body 202 and hold each internal component in place. In some embodiments, the attachment members 312 may be retaining fingers extending from the control unit body 202. These retaining fingers may act as snap-in fittings or pressure fittings capable of holding each internal component in place. In alternative embodiments, the attachment members 312 may include clips, push pins, screws, bolts or other fasteners extending through one or more sections of an internal component to hold the component in place against the housing of the control unit 200.

Embodiments of a power supply 311 may be any device that is capable of providing electrical power to the internal components of the control unit 200. The power supply 311 may store energy and supply DC current to the electrical circuits of the control unit 200. As shown in FIG. 3c, the power supply may provide a voltage of 5v to the electrical circuit in some embodiments. In other embodiments, the power supply may be able to supply alternative voltages necessary to power the components of the circuit, such as 3.3v, 9v, or 12v of power. Examples of a power supply 311 may include rechargeable or non-rechargeable batteries, including but non-limited to lead acid batteries, lithium batteries, lithium ion or lithium polymer (Li—Po) batteries, nickel metal hydride (NiMH) batteries, alkaline batteries, carbon-zinc batteries and nickel cadmium batteries.

In some embodiments of the control unit 200, the power supply 311 may be recharged using a power supply charger 305 which may be contained within the control unit 202. Embodiments of the power supply charger 305 may be equipped with an input port 306 which may receive electrical energy from a separate power source and may be capable of transferring energy from the external source such as a computing device, wall outlet or external battery to the internal power supply 311 of the control unit 200. Embodiments of the power supply charger may include USB, USB mini or USB micro chargers, wherein each type of charger 305 may be equipped with a corresponding USB port, USB mini port or USB micro port, capable of receiving a USB cable, USB mini cable or USB micro cable respectively. Moreover, in alternative embodiments the power supply charger may be a thunderbolt charger capable of receiving a thunderbolt cable, firewire charger having a firewire port capable of receiving a firewire cable or a AC or DC power charger having an AC or DC port, capable of receiving an AC adapter or DC power cable.

In some embodiments of the control unit 200, the control unit 200 may include a voltage regulator 307. The voltage regulator 317 may installed to maintain a constant voltage throughout the electrical circuit being supplied electricity from the power supply 311. The voltage regulator 307 may have a set or fixed reference voltage that is compared with the output voltage received from the power supply 311. Accordingly, in some embodiments, the voltage regulator may increase the voltage up to the set or fixed voltage (if possible) when the voltage supplied by the power supply is too low. Alternatively, when the voltage of the power supply is too high, the voltage regulator 307 may drop a portion of the power source voltage supplied so that the fixed amount of voltage is supplied to the remaining components of the electrical circuit.

In some embodiments of the control unit 200, the control unit 200 may include a microcontroller 309. A microcontroller 309 may refer to a small computing system 11 and may include components of the generic computing system shown in FIG. 4. The computer system 11 of the microcontroller 309 may be single integrated circuit in some embodiments. The components of the microcontroller 309 may include on the single circuit, a processor 403, memory device 25, 405 and programmable input 413 or output 415 peripherals such as the sensor input device 31, video input device 33 and/or audio input device 35. Examples of a microcontroller may include Nios 16 bit, Nios II 32-bit, ARM7, AT89, AT90, ATtiny, ATmega, ATxmega, AT91SAM, AVR32, Cypress Semiconductors such as the Cypress M8C, 8051, ARM Cortex-M0, ARM Cortex-M3, 12 and 14 bit Microchip PIC microcontrollers, Freescale S08, Freescale S12, Freescale DSP, Freescale MPC line and the Intel family of microcontrollers, just to name a few including the MCS-48, MCS-51, MCS151, MCS-251, MCS-96 and MCS-296. Current brands may include Arduino, Rasberry Pi, MSP430 Launch Pad, Nanode, Pinguino PIC32, STM32 Discovery, and the Teensy 2.0 microcontroller. In the exemplary embodiment shown in FIG. 3b, an ATmega328 microcontroller is depicted.

The microcontroller 309 may have programmable computer program code 407 loaded in the memory 405 or memory device 25 of the microcontroller 309. The computer program code 407 may be loaded as a program, application, module or other software and may include programmable instructions designating commands that may be provided to one or more peripherals connected to the microcontroller 309, such as the mode management module 14, recording module 15, reporting module 17 and location module 19 of the automated response module 14.

In some embodiments, additional peripheral devices may be placed in communication with the microcontroller 309 either via a direct connection to the computer system 11, 401 via an I/O interface 27, 409 or by establishing a network 40. Examples of peripheral devices may include data storage devices 29, 411, network computer systems 41 including but not limited to mobile communication devices, application servers, dispatch computing devices, fleet management systems, computer aided dispatch devices, network data storage 43, input device 413 such as the sensor input device 31, video input device 33, audio input device 35, microphone 304, output devices 415 such as a speaker or display device that connect or operate in conjunction with the computer system 11, 401.

In embodiments of the control unit 200, peripheral devices may also include any additional devices that may connect to or be controlled by a computer system 11, 401 such as the microcontroller 309. These peripheral devices may include one or more of the following, a microphone, transmitter, transceiver, receiver, data storage device such as a USB flash drive, SD card, solid state drive, hard drive or other non-transitory media, camera, speaker, display device such as a monitor, LCD or LED screen, mouse, keyboard or other input device.

In the exemplary embodiment of the control unit 200, the peripherals being controlled by the microcontroller 309 may include a microphone 304 and a transmitter/transceiver 302 connected to the microcontroller 309. The microcontroller 309 may be programmed with instructions to activate, operate, control or provide commands to the microphone 304 and/or the transmitter/transceiver 302 in accordance with the software program or module loaded in the memory device 25, 403 of the microcontroller 309, as computer program code 407. As described above, the hardware modules or software programs loaded into the memory device 25, 403 of the microcontroller may include the automated response module 13 shown in FIG. 1a, 1b.

In some embodiments of control unit 200, the microphone 304 may be built or fastened into the control unit 200 directly, while in alternative embodiments, the microphone may be positioned externally to the control unit 200 and communicate via a wire or wirelessly with a receiver inside the control unit 200. For example, a wireless or wired microphone may be positioned on the clothing of a user. Any sounds or voice data received by the exterior microphone may be transmitted via a wire or wireless signal to the receiver peripheral connected to the microcontroller 309 or other computer system 11, 401, 41. A wireless signal may include any type of signaling medium that can transmit data or information without a wire, including radio signals, Wi-Fi, Bluetooth, Bluetooth low energy (BLE), infrared and ultrasonic communication. Types of microphones may include dynamic, condenser, electrotet, unidirectional, bi directional, omnidirectional or a combination of microphones thereof. In the exemplary embodiment, an omni directional electrotet microphone may be used.

Embodiments of the microphone 304 may be switched between an on or off mode manually or automatically. For instance, activation of the microphone 304 into a listening mode that records audio data or other voice data, and environmental sounds may be performed when the system 11, 200, 401 is placed into active mode by the mode management module 14. In some embodiments, when the switching mechanism 103 places the system into an active mode, power from the power supply 311 can flow through the circuit and thus activate the microcontroller 309 and each of the peripheral components connected thereto. In other embodiments, the computer system 11, 401 such as the microcontroller 309 may activate the microphone 304 as a function of the sensor input device 31. When the sensor input device indicates that a weapon 105 has been removed from a holster 100, the computer system 11 may activate the microphone 304 to begin collecting audio data or voice data.

In alternative embodiments, the microphone 304, although receiving power from the power supply, may not be placed in a listening mode automatically when the system 11, 200, 401 is switched into active mode by the external switching mechanism 103 or sensor input device. Instead, the microphone 304, other audio input device 35 or video input device 33 may be activated manually using a separate input or command such as a separate button, switch or input, including physical or virtual inputs located on a separate computing device, such as a network computing device 41 connected to the control unit 200. The input or command may implement programmable instructions indicating to the microcontroller or other computer system 11, 401 that the microphone, audio input device 35 or video input device should activate and begin collecting data.

Embodiments of the control unit 200 may further include one or more transmitters or transceivers 302. These transmitters or transceivers may be connected to the microcontroller 309 or other computer system 11, 41, 401. A “transmitter” may refer to any electronic device originating, generating or undergoing a transfer of information or data from a source to a receiver. The information being transferred by the transmitter may include video data, sound data, or any type of electronic data, including file information. A “transceiver” 302 on the other hand may be any electronic device that can act as both a transmitter and a receiver of information or data. Examples of transmitters and transceivers may include but are not limited to radio antennas, Wi-Fi antennas, Bluetooth, BLE, cellular antennas, GPS, satellite, RFID, or any other transmitter capable of transferring audio, video or computer file information from one computing device to another over a network 40.

Embodiments of the transmitter 302 may broadcast the information being transferred to a receiver either through a wire or wirelessly. In some embodiments, the transmitter 302 may transfer information created or stored by a peripheral device, computer system 11, 200, 401, network computer system 41 or network data storage device 43. For example, the transmitter may transfer or broadcast audio data, voice data or visual data created by audio input device 35 (e.g. microphone 304) or a video input device 33 (e.g camera) to a third party requesting or receiving the transferred data, such as a network computer system 41. In the exemplary embodiment of FIG. 3b, a Bluetooth transceiver may be installed within the control unit 200. The Bluetooth transceiver 302 may send audio and voice data recorded and saved by the microphone 304 to a network computer system 41, paired to the transceiver 302. Moreover, the transceiver 302 may receive information transmitted by the network computer system to the transceiver 302.

Embodiments of the control unit 200 and other computer systems 11, 401 may be configured to be connected, or communicate with, or be controlled by network computer system 41. The control unit 200 or other computer system 11, 401 may establish a network communication link with the network computer system 41 via a network 40 connection established via the transmitter or transceiver 302 of the control unit 200 or other hardware or software utilizing a network interface controller 23. In the exemplary embodiment, the network 40 connection may be established by pairing the Bluetooth transceiver 302 with a transmitter, transceiver or receiver peripheral connected to the network computing system 41. Other types of network connections that may be established may include cloud-computing environment (including a public cloud, private cloud, or community cloud), an enterprise private network (EPN), a local area network (LAN), a wide-area network (WAN), personal area network (PAN), storage area network (SAN), virtual private network (VPN) a wireless or distributed network, peer-to-peer network, shared data network or any other type of real or virtual network platform known to those skilled in the art.

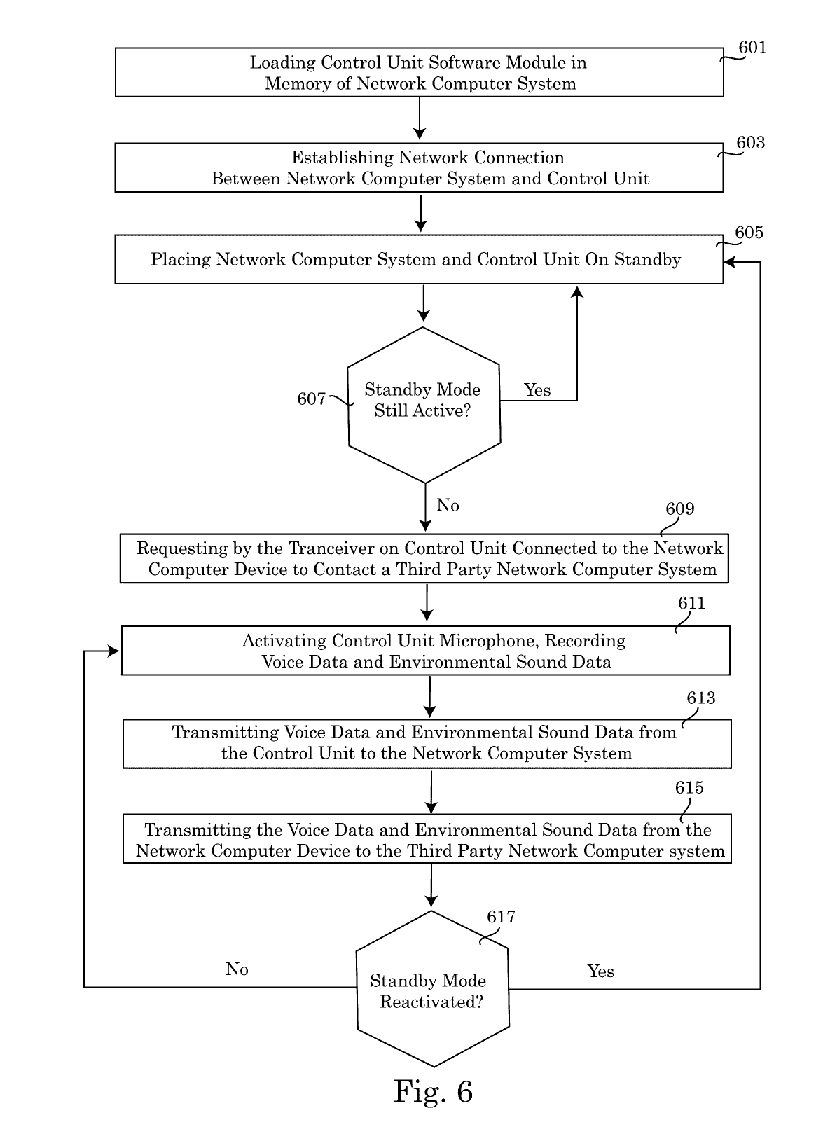

Referring to the drawings, FIG. 4 illustrates a block diagram of a generic computer system that may be included in the systems of FIGS. 1a-3c, 5a, 5b and for implementing methods of FIG. 6. The embodiment of a computer system 401 capable of transferring information and data, including sound data or visual data recorded by computer system 11 or control unit 200. The embodiment of a general computing system 401 may generally comprise a processor 403 coupled through one or more I/O Interfaces 409 to one or more data storage devices 411, one or more input or output (I/O) devices 413 and 415.

Hardware data storage devices 411 of computer system 401 may include, but are not limited to, magnetic tape drives, fixed or removable hard disks, optical discs, storage-equipped mobile devices, and solid-state random-access or read-only storage devices. I/O devices may comprise, but are not limited to: input devices 413, such as keyboards, scanners, handheld telecommunications devices, touch-sensitive displays, tablets, cameras, biometric readers, joysticks, trackballs, or computer mice; and output devices 415, which may comprise, but are not limited to printers, plotters, tablets, mobile telephones, displays, or sound-producing devices. Data storage devices 411, input devices 413, and output devices 415 may be connected to the computer system 401 either locally or at remote location from which they may be connected to I/O Interface 409 through a network interface or specialized hardware, such as a Bluetooth transceiver, BLE transceiver, Wi-Fi antenna, radio antenna or IR transceiver. Processor 403 may also be connected to one or more memory devices 105, which may include, but are not limited to, Dynamic RAM (DRAM), Static RAM (SRAM), Programmable Read-Only Memory (PROM), Field-Programmable Gate Arrays (FPGA), Secure Digital (SD) memory cards, SIM cards, or other types of memory devices.

At least one memory device 405 may contain computer program code 407, which may be a computer program that comprises computer-executable instructions. The stored computer program code 407 may include a program that performs a transfer of information and data recorded or saved by the control unit 200 (recording module 15) of holster 100 and forwards the information and data to a network computer system via a reporting module 17 in accordance with embodiments of the present disclosure. The computing system 11, 401 may implement other embodiments described in this specification, including the method illustrated in FIG. 6. In some embodiments, the data storage devices 29, 411 may also store the computer program code 407. Processor 403 may execute the stored computer program code 407. In some embodiments of the computing system 401, the computer program code 407 stored in the storage devices 411 may be configured to be launched by processor 403 via the memory devices 405.

In some embodiments, rather than being stored and accessed from a hard drive, optical disc or other writeable, rewriteable, or removable hardware data-storage device 411, stored computer program code 407 may be stored on a static, nonremovable, read-only storage medium such as a Read-Only Memory (ROM) device 405, or may be accessed by processor 403 directly from such a static, non-removable, read-only medium 405. Similarly, in some embodiments, stored computer program code 407 may be stored as computer-readable firmware 405, or may be accessed by processor 403 directly from such firmware 405, rather than from a more dynamic or removable hardware data-storage device 411, such as a hard drive or optical disc. Thus the present disclosure discloses a process for supporting computer infrastructure, integrating, hosting, maintaining, and executing computer-readable code into the computer system 401 wherein the code in combination with the computer system 401 is capable of collecting, receiving and communicating the information and data created by the computer system 11 and/or control unit 200 and transmitted to a third party operating a network computer system 41.

In the exemplary embodiment of the network computing system 41 connecting to the computer system 11 or control unit 200 of holster 100, the network computing system 41 may be a portable or handheld device that may be kept on the user of the holster 100. Examples of portable computing systems 41, 401 may include a cellular telephone, smart phone, laptop, tablet, PDA, network enabled media devices or other devices having the features of the computing system 11, 401 as described in current application or computer system 11. By keeping the network computing system 41 (such as a mobile communication device) on the person of the user of the holster 100, the network computing system 41 may always be within the range of the computer system 11 (e.g. the control unit 200) of the holster 100. While one or more of the network computing systems 41 may be placed in a secondary location separate from the user of the holster 100, such as a vehicle or police car a user exiting the vehicle or location where the network computing system 41 is kept may exceed the range of the network interface controller 23, transmitter/transceiver 302 of the computer system 11 or control unit 200.

Embodiments of the network computing system 41 may include computer program instructions loaded in the memory of the network computing system 41. The computing program instructions may include instructions for software that controls the audio input device 35 (e.g. microphone), the video input device 33 (e.g. camera) and transmission of recorded audio or visual data to a third party that may be operating a network computer system 41.

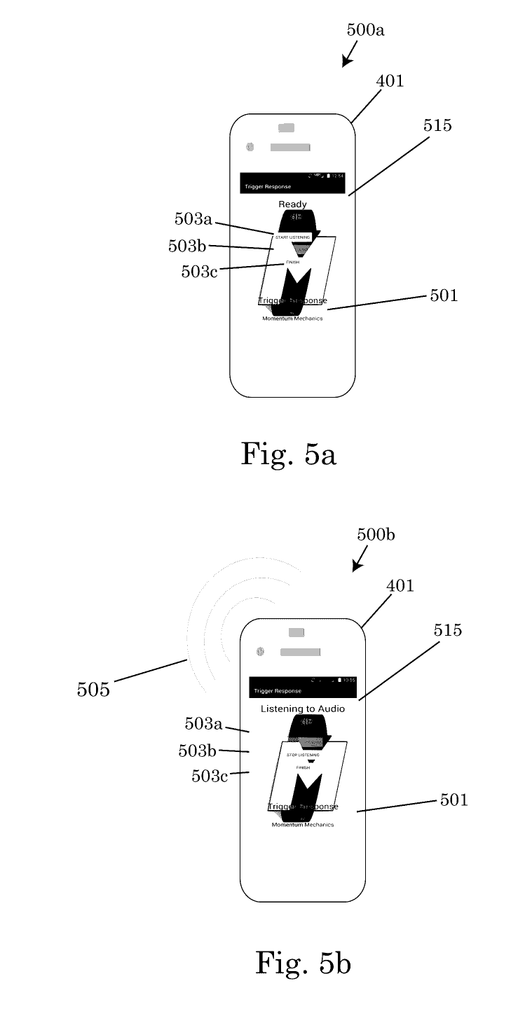

Referring to FIG. 5a, the computer program, software, or module containing the computer program instructions may be displayed as a graphical user interface (GUI) 501 on the display 515 of a network computing system 41. In some embodiments, the GUI may include one or more inputs 503a, 503b, 503c which may send commands via a network 40 to the transmitter or transceiver 302 of the control unit 200 or other computer system 11. The inputs 503a, 503b, 503c may include commands such as those instructing the computer system 11 or control unit 200 to stop or start recording audio and/or video and to transmit the data of the recorded audio or video to a third party. One input of the computing device may place the control unit in an active mode that listens, watches and or records the surroundings of the user, while a second input may place the control unit in a standby mode that stops the recordation of information.

In one embodiment, a user may be equipped with a holster 100 having the control unit 200. The user may also have a network computer system 41, present having one or more program instructions loaded in the memory of the computing device that is capable of controlling or sending commands to the control unit 200. The network computing system 41 and the control unit 200 of the holster 100 may establish a network connection through a protocol such as Bluetooth pairing or Wi-fi. At some point during the use of the holster 100, the user may encounter a situation or event where it may be wise to record audio or video information of the user's surroundings, including voice data. However, in some embodiments, the encounter or situation may not be necessary for an officer to un-holster their weapon, but evidence of the encounter may be wanted as evidence leading up to an event. A user may initiate the microphone 304 or camera peripherals or other audio or video input device 33, 35 of the control unit 200 or other computer system 11, via the inputs 503a, 503b, 503c of the network computing system 41 without un-holstering or removing the weapon 105 from the holster 100. Accordingly, a user controlling the control unit 200 or other computer system 11 remotely via the input 503a, 503b, 503c may instruct the control unit 200 or other computer system 11 to record the audio or video information, save the audio or video information, transmit the audio and video information to the network computing system 41 for storage, or stream the information via the computing device to a third party operating a separate network computing device 41 (for example a dispatcher at a dispatch center).

In some situations, a user may not have activated the computer system 11 or control unit 200 ahead of time via the network computing system's 41 remote programming software. A user however may find themselves in an unexpected situation where recording and transmitting information to a third party network system is desired or necessary protocol. Accordingly, the control unit 200 or other computing system 11, connected to the network computing system 41 may automatically begin recording and/or streaming audio or visual data to a third party network computing system as soon as the switching mechanism 103 changes position or a sensor of the sensor input device 31 of the holster senses the removal of weapon 105.

As soon as the signal from the switching mechanism 103 or sensor input device 31 has been detected, the control unit 200 or other computer system 11 may establish a network connection with the network computing system 41 if a network connection has not been previously established. In some embodiments, the connection to the network computing system 41 may have been previously established, by the computer system 11 or control unit 200. In some embodiments, the establishment of the connection may be the signal to the computing system 11 to transmit or transfer the recorded data to the network computing system of a third party, including audio data, visual data, and GPS information.

Simultaneously or near simultaneously while the network connection is being established, the computer system 11, such as the microcontroller 309 of the control unit 200 may activate or initiate a peripheral designated to record audio or visual data such as the video input device 33 (camera) or audio input device 35 (microphone 304). The recorded data may be transmitted to a receiver connected to network computing system 41 (such as a mobile communication device) whereby the receiving network computing system 41 acts as a transmitting system for contacting a third party network communication system connected to network 40. The network computing system controller by the user may transmit the information collected by the control unit or other computer system 11 to a third party computing system connected to the network 40, send out a request for assistance or emergency services and/or provides additional identifying information including location information.

Embodiments of a “third party” network computer system 41 may include any individual person operating a network computing system or a computing device other than the computer system 11 operated by the user, control unit 200 or network computing system paired with the control unit 200. In some embodiments, the third party may be fellow personnel designated to assist the user such as a fellow police officer or armed personnel, a dispatcher or 911 operator.

Embodiments of additional identifying information that may be provided along with the recorded information may include but is not limited to the user's name, and image of the user, user location information such as through GPS, officer badge number, and a radio frequency or phone number where the officer can be reached. In some embodiments, the radio frequency or phone number may not be necessary because the computing device may automatically establish a line of communication with the third party. This may allow the user, such as a police officer to request assistance or help from a dispatcher or fellow officer without having to radio for assistance themselves and without having to remove their focus from a suspect while their weapon is drawn.

### Method for Automating Communication

Referring back to the drawings, FIG. 6 provides an example of a flow diagram describing one embodiment of a method for using the automated response and communication system 10 to request assistance and record informational evidence that may be useful after an event has taken place. Embodiments of the method may include a first step of loading 601 a control unit or computer system with a computer program code for software in the memory of the network computing system that is capable of communicating with and/or controlling the control unit of the computer system. The method may further include the step of establishing 603 a network connection between the network computing device and the control unit. As described above, the network connection may allow for the transfer of information, data and requests back and forth between the control unit of the automated response and communication system and the network computing system.

As also stated above, embodiments of the method for using the automated response and communication system may include step 605 which may include the step of placing the network computing system and the control unit in a standby mode once a network connection has been established. The standby mode may be a default mode once the network connection between the control unit 200 and the network computing system is made. The standby mode may also be manually set by the user via the network computing system. While in standby mode, the control unit 200 and its peripheral devices may not be engaged in collecting audio or visual data.

Simultaneously, the control unit may be continuously checking in step 607 whether or not the standby mode is still active on the control unit 200 or the network computing system. It may be determined that standby mode is no longer active if the switching mechanism 103 has communicated to the control unit 200 a change in position from a secured position of a weapon to an unsecure position. Likewise, in an embodiment utilizing sensors, standby mode may be determined to no longer be active as a function of one or more sensor input devices transmitting sensor data to the control unit indicating that a weapon has been removed from a holster. In other embodiments, the control unit it may be determined that standby mode is no longer active if the user has manually switched the mode from standby mode to an active mode.

If it is determined by the control unit that assistance is required, then microcontroller 309 of the control unit may proceed by requesting in step 609 that the transmitter or transceiver 302 of the control unit 200 contact a third party. In some embodiments, this request for assistance may be sent to the network computer system by transmitting the request via the transceiver 302. Simultaneously or near simultaneously, with the requesting step of the method, the control unit 200 may perform in step 611 the step of activating a peripheral device connected to the control unit, such as a microphone or camera. Furthermore, the audio or video data information and data recorded by the microphone or camera may be stored by a storage device integrated with or connected to the control unit

In step 613, the control unit may proceed by transmitting the information collected by each of the peripheral devices connected to the control unit, include the voice data, environmental sounds and/or video data to the network computer system paired with the control unit. The network computer system may further transmit the audio data, voice data, environmental sound data to a third party network computer system operated such as a dispatcher, colleague, application server, automated dispatching system, etc.

Subsequently, in step 617, the control unit 200 may further identify whether standby mode has been reactivated by replacing the weapon 105 into the holster 100, returning the operating mode from active mode to standby mode, or by manually returning the control unit to standby mode via the programmed software loaded onto the network computer system paired with the control unit. If standby mode is not reactivated, the control unit 200, may continue to record and transmit information to the network computer device and ultimately continue to transfer the information to a third party operating a separate network computing device. However, if standby mode is reactivated, the recordation and transfer of audio and visual data may cease until the control unit enters active mode again.

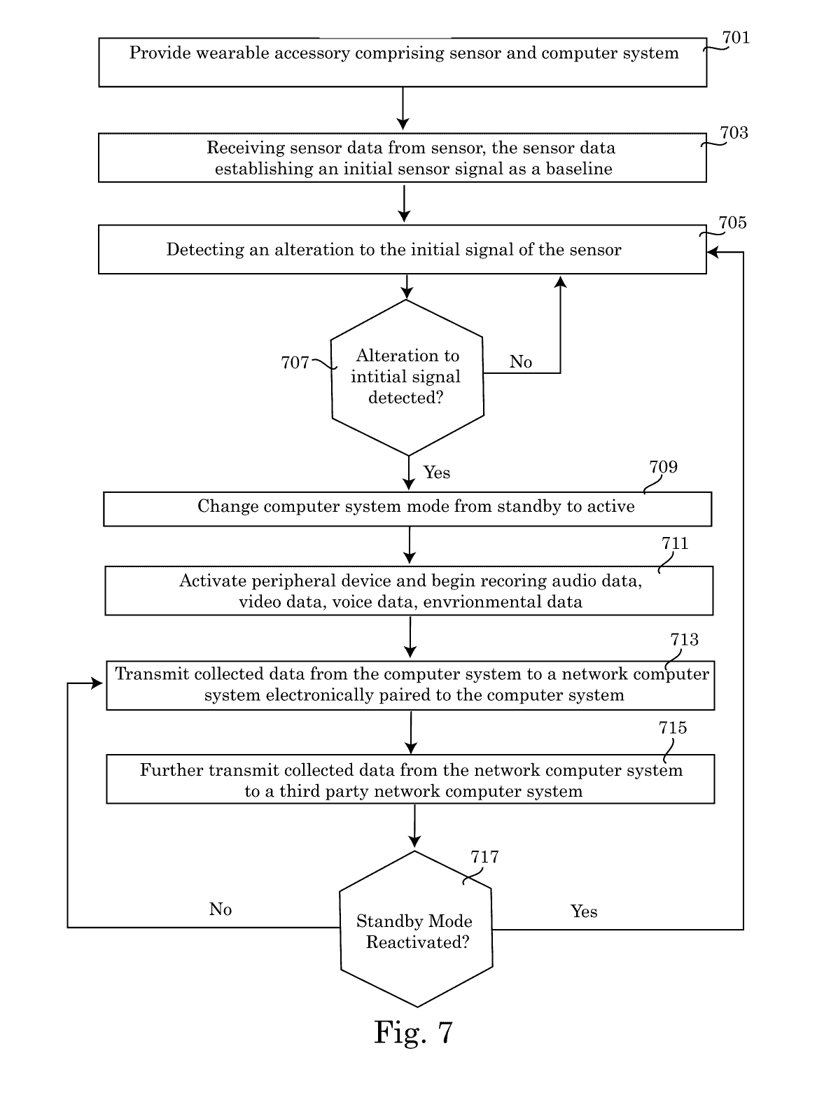

FIG. 7 depicts an alternative embodiment of a method for automating communication, data collecting and reporting to a third party as a function of a change to a weapon status detected by a sensor input device 31. The method may begin at step 701 by proving a wearable accessory such as a holster 100, clothing, belt, belt buckle, or other wearable accessory. The wearable accessory may comprise a sensor attached to a sensor input device 31, wherein said sensor of the sensor input device is in communication with a computer system 11, 200, 401.

In step 703, the computer system 11, 200, 401 may receive sensor data from the sensor input device 31. The initial sensor data may be considered the sensor data that establishes an initial sensor signal. In the exemplary embodiment, the initial sensor signal may identify the wearable accessory securely affixing a weapon into a secured position. For example, a holster that is holstering a firearm may emit a specific initial signal from the sensor input device to the computer system 11, 200, 401. As the weapon remains affixed to the wearable accessory, the initial signal may remain constant.

In step 705, the sensor of the sensor input device may detect an alteration to the initial signal previously emitted by the sensor, indicating a change in the presence of the weapon from a secured position to an unsecured or released position. For example, using the holstered firearm example above, when the firearm is removed from the holster, the sensor input device 31 may detect the removal of the firearm from the holster and transmit the altered sensor signal to the computer system 11, 200, 401. If in step 707, no alteration to the initial signal has been detected, the computer system 11, 200, 401 may remain in standby mode and continue to monitor the sensor data provided by the sensor to the computer system 11, 200, 401.

On the other hand, if in step 707, the computer system 11, 200, 401 receiving the sensor data detects an alteration in the initial signal, the mode management module 14 of the computer system 11, 200, 401 may change the mode from passive to active in step 709. Subsequently in step 711, as a function of the change in the mode to an active mode, the computer system 11, 200, 401 may initiate via the recording module 15 a peripheral device such as an audio input device 35 or video input device 33 and begin recording data.

In step 713, the computer system 11, 200, 401 may transmit the data collected by the recording module 15 to a first network computer system 41 which may be electronically paired to the computer system 11, 200, 401. The exemplary embodiment of the paired network computer system 41 may be a mobile communication device. In step 715, the first network computer system 41 may further transmit the recorded data received from the computer system 11, 200, 401 to a third party network computer system such as a colleague's computer system, 911 operator, dispatcher, automated dispatch device, a fleet management system providing instructions to one or more employees or colleagues, a vehicle computer system. In some embodiments, the step of further transmitting the collected data during step 715 may further include opening a line of communication between the electronically paired network computer system and the third party network computer system.

In some embodiments the computer system 11, 200, 401 may continue to receive sensor data from the sensor input device 31 while the computer system 11, 200, 401 is in active mode. The computer system receiving the sensor data may determine whether or not the sensor has re-established the initial sensor signal. The re-establishment of the initial sensor signal may indicate to the computer system that the wearable accessory has re-secured the weapon into a secured position. Thus in step 717 if the sensor device has re-established the original initial sensor signal, the computer system may reactivate standby mode due to the indication that the weapon has be re-secured, for example the firearm has be re-placed into holster 100. Conversely, if the standby mode has not been reactivated in step 717, the computer system 11, 200, 401 may continue to record and transmit the data collected by the peripheral devices connected to the computer system.

While this invention has been described in conjunction with the specific embodiments outlined above, it is evident that many alternatives, modifications and variations will be apparent to those skilled in the art. Accordingly, exemplary embodiments of the invention as set forth above are intended to be illustrative, not limiting. Various changes may be made without departing from the spirit and scope of the invention as defined in the following claims. The claims provide the scope of the coverage of the invention and should not be limited to the specific examples provided herein.

The claims are as follows:

1. A method for automating communication comprising the steps of:
receiving, by a computer system connected to a sensor of a wearable accessory, sensor data establishing an initial signal of the sensor, wherein the initial signal is detecting a presence of a weapon in a secured position;
detecting, by the computer system, an alteration to the initial signal of the sensor, indicating a change in the presence of the weapon in a secured position;
activating, by the computer system, a peripheral device connected to the computer system, as a function of the alteration to the initial signal of the sensor;
receiving, by the computer system, data collected by the peripheral device selected from the group consisting of audio data, video data, voice data and environmental data; and
transmitting, by the computer system, the data collected by the peripheral device to a network computer system connected to the computer system.

2. The method of claim 1 wherein, the wearable accessory is a holster securing the weapon in a secured state.

3. The method of claim 1, wherein the computer system is a control unit comprising a microprocessor, a microphone and a Bluetooth transmitter.

4. The method of claim 2, wherein the initial signal detecting a presence of a weapon in a secured position is sensor detecting the weapon secured into the holster.

5. The method of claim 4, wherein the alteration to the initial signal of the sensor occurs as a function of the weapon being removed from the holster.

6. The method of claim 1, wherein the peripheral device connected to the computer system is a microphone and a video camera, wherein the microphone and video camera record audio data, video data, voice data and environmental data.

7. The method of claim 1, wherein the network computer system is a mobile communication device electronically paired to the computer system.

8. The method of claim 7, further comprising the steps of:
further transmitting, by the network computer system electronically paired to the computer system, the data collected by the peripheral device to a second network computer system of a third party.

9. The method of claim 8, wherein the third party is selected from the group consisting of a dispatcher, 911 operator, vehicle computer, application server, fleet management system and a computer aided dispatch device.

10. A computer system, comprising:
a processor;
a memory device coupled to the processor;
a wearable accessory connected to a sensor coupled to the processor; and
a computer readable storage device couple to the processor, wherein the storage device contains program code executable by the processor via the memory device to implement a method for automating communication comprising the steps of:
receiving, by the processor, sensor data establishing an initial signal of the sensor, wherein the initial signal is detecting a presence of a weapon in a secured position;
detecting, by the processor, an alteration to the initial signal of the sensor, indicating a change in the presence of the weapon in a secured position;
activating, by the processor, a peripheral device connected to the computer system, as a function of the alteration to the initial signal of the sensor;
receiving, by the processor, data collected by the peripheral device selected from the group consisting of audio data, video data, voice data and environmental data; and
transmitting, by the processor, the data collected by the peripheral device to a network computer system connected to the computer system.

11. The system of claim 10 wherein, the wearable accessory is a holster securing the weapon in a secured state.

12. The system of claim 10, wherein the computer system is a control unit comprising a microprocessor, a microphone and a Bluetooth transmitter.

13. The system of claim 11, wherein the initial signal detecting a presence of a weapon in a secured position is the sensor detecting the weapon secured into the holster.

14. The system of claim 13, wherein the alteration to the initial signal of the sensor occurs as a function of the weapon being removed from the holster.

15. The system of claim 10, wherein the peripheral device connected to the computer system is a microphone and a video camera, wherein the microphone and video camera record audio data, video data, voice data and environmental data.

16. The system of claim 10, wherein the network computer system is a mobile communication device electronically paired to the computer system.

17. The system of claim 16, further comprising the steps of;
further transmitting, by the network computer system electronically paired to the computer system, the data collected by the peripheral device to a second network computer system of a third party.

18. The system of claim 17 wherein the third party is selected from the group consisting of a dispatcher, 911 operator, vehicle computer, application server, fleet management system and a computer aided dispatch device.

19. A computer program product comprising:
one or more computer readable hardware storage devices having computer readable program code stored therein, said program code containing instructions executable by the one or processors to implement a method for automating communication comprising the steps of:
receiving, by the processor, sensor data establishing an initial signal of a sensor, wherein the initial signal is detecting a presence of a weapon secured into a holster;
detecting, by the processor, an alteration to the initial signal of the sensor, indicating a removal of the weapon from the holster;
activating, by the processor, a microphone and a camera connected to the holster, as a function of the alteration to the initial signal of the sensor;
receiving, by the processor, data collected by the microphone and camera selected from the group consisting of audio data, video data, voice data and environmental data; and
transmitting, by the processor, the data collected by the microphone and the camera to a network computer system electronically paired to the processor, wherein the network computer system is a mobile communication device.

20. The computer program product of claim 19, further comprising the steps of:
further transmitting, by the mobile communication device, the data collected by the microphone to a second network communication system of a third party selected from the group consisting of a dispatcher, 911 operator, vehicle computer, application server, fleet management system and a computer aided dispatch device.
